(19) United States
(12) Patent Application Publication
(10) Pub. No.: US 2019/0337519 A1
(43) Pub. Date: Nov. 7, 2019

(54) METHOD AND DEVICE FOR CONTROLLING THE POWER AVAILABLE ON AN ELECTRIC TRACTION CHAIN OF A HYBRID POWERTRAIN

(71) Applicant: NISSAN MOTOR CO., LTD., Yokohama-shi, Kanagawa (JP)

(72) Inventors: Ahmed KETFI-CHERIF, Elancourt (FR); Ludovic MERIENNE, Gif Sur Yvette (FR); Loïc LE MAO, Boulogne-Billancourt (FR)

(73) Assignee: NISSAN MOTOR CO., LTD,, Yokohama-shi, Kanagawa (JP)

(21) Appl. No.: 16/314,026

(22) PCT Filed: Mar. 30, 2017
(86) PCT No.: PCT/FR2017/050733

§ 371 Date: Dec. 28, 2018

(30) Foreign Application Priority Data
Jun. 30, 2016 (FR) 1656202

(51) Int. Cl. B60W 30/19; B60L 50/61; B60W 10/105; B60W 20/19; B60K 6/547

(52) U.S. Cl. CPC B60W 30/19; B60L 50/61; B60K 6/28; B60W 20/19; B60K 6/547; B60W 10/105

(57) ABSTRACT

A method for controlling the power available on the electric traction chain of a powertrain (GMP) consisting of a heat engine that can transmit the torque from same to the wheels at different transmission ratios, a first electric machine (ME), a second electric machine (HSG) linked alternately to the input shafts of the heat engine or of the first electric machine (ME) in the powertrain (GMP), and a battery supplying power to the electric machines, characterised in that the supply voltage of the electric machines is established by a DC/DC voltage converter (13) arranged between the terminals of the battery and those of the electric machines, capable of imposing on them a voltage equal to that of the battery (Ubat), or indeed a voltage (Udc) higher than same.

### TECHNICAL FIELD

The present invention relates to the control of the power available on an electric traction chain of a hybrid vehicle.

More precisely, the object thereof is a method for controlling the power available on the electric traction chain of a powertrain consisting of a combustion engine that can transmit the torque thereof to the wheels over various transmission ratios, of a first electric machine of a second electric machine linked alternately to the input shafts of the combustion engine or of the first electric machine in the powertrain, and of a supply battery for the electric machines.

### BACKGROUND ART

The publication WO 2014/207332 describes a hybrid drive of this type, having several ratios, that are electric, combustion and hybrid, where the torques of the combustion engine and of at least one electric machine are added in the direction of the wheels. The combustion-generated torque is transmitted to the wheels over a “combustion” transmission ratio, and the traction torque of the main electric machine is done so over an “electric” ratio. During changes in the combustion transmission ratio in hybrid mode (combining the combustion and electric tractions), the torque of the combustion engine is interrupted. The torque of the secondary electric machine is then driven to synchronize the combustion engine with the new ratio thereof, while providing torque to the wheel via the main electric machine.

In practice, the electrical architecture of the vehicle, in particular the power available on the main electric machine, limits the input thereof. Retaining a purely electrical traction up to relatively high speeds, for example up to 80 km/h, is limited by the voltage level of the battery. The voltage is often too weak, even at full charge, to develop the entire desired traction electric power. The phenomenon worsens as the charge state decreases. When the powers of the two electric machines can be combined, the performances of the electric traction chain remain insufficient, despite the input of power of the secondary electric machine, which is limited by the voltage level.

Moreover, if there is little compensation for the interruption of the combustion torque during the combustion ratio changes, the driver and passengers of the vehicle feel this shifting like that of a robotized transmission having torque break.

### SUMMARY OF INVENTION

### Problems to be Solved by Invention

It is therefore desirable to improve the performances of the electric traction chain, particularly on non-rechargeable hybrid vehicles, in order to have a higher power for pure electric driving, and in order to soften the torque break felt during the ratio changes on the combustion traction chain.

The aim of the present invention is to increase the available power, in order to raise the speed accessible for electric driving, and to soften the power gap during the combustion transmission ratio changes.

### Means for Solving Problems

To this end, it proposes that the supply voltage for the electric machines is established by a DC voltage [ML1] converter, arranged between the terminals of the battery and those of the electric machines, which is able to impose on them a voltage equal to that of the battery, or a voltage that is greater than this.

This measure makes it possible to increase the power available on the electric traction chain, particularly at high speed.

In a particular embodiment of the invention, the voltage converter imposes the voltage of the battery on the electric machines, when the acceleration request of the driver through the accelerator pedal thereof remains weak, and imposes on them a voltage that is greater than this, when the driver requests a strong acceleration.

The DC voltage [ML2] converter, which is arranged between the terminals of the battery and those of the electric machines, can impose, according to required conditions, a voltage equal to that of the battery, or a voltage greater than this.

The present invention makes it possible to simultaneously solve the two technical problems cited, which are encountered, for example, on a motive power hybrid powertrain non-rechargeable on the electric network on the ground, with an on-board voltage of approximately 200 V, and a relatively low capacity, of a few hundred Wh.

The preferred use of this invention is on a powertrain consisting of a combustion engine linked to a first transmission input shaft which can transmit the torque thereof to the wheels over various transmission ratios, of a first electric machine linked to a second input shaft of the transmission, and of a second electric machine linked alternately to the first or to the second input shaft of the transmission.

### Effect of Invention

According to the present invention, it is possible to increase the power available on the electric traction chain, particularly at high speed.

### BRIEF DESCRIPTION OF DRAWINGS

It will be better understood on reading the following description of a particular embodiment thereof, with reference to the appended drawings in which:

FIG. 1 is a hybrid architecture diagram,

FIG. 2 groups together the shifting curves thereof,

FIG. 3 identifies the ratios requested with respect to these curves,

FIG. 4 is a simplified diagram of the circuit of the electric machines,

FIG. 5 superimposes the speed and accelerator pedal depression curves, in the event of strong acceleration,

FIG. 6 shows the corresponding variation of the voltages in the circuit,

FIG. 7 shows the combination of the powers, and

FIG. 8 illustrates the use of the invention for a combustion ratio change.

### MODE(S) FOR CARRYING OUT THE INVENTION

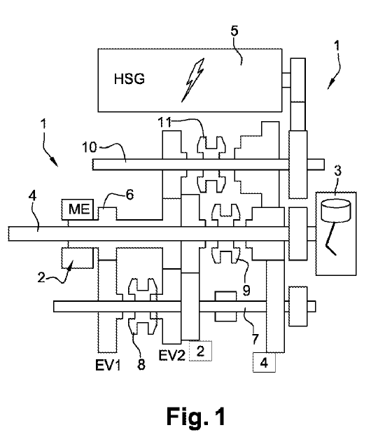

The transmission 1 of FIG. 1 is, for example, of “robotized” type, i.e. the operation thereof is that of a manual transmission, but the gear shifts are automated. The diagram shows an electric machine, called a HSG (meaning high-voltage starter generator) 5, and a combustion engine 3 on a solid primary shaft 4. Another electric machine 2 called ME, more powerful than the first electric machine, is mounted on a hollow primary shaft 6. The secondary shaft 7 of the transmission is connected to the differential (not shown), then to the wheels of the vehicle.

The first jaw clutch 8, located on the secondary shaft 7, makes it possible to modify the ratio of the electric machine ME 2, independently of the rest of the transmission, in order to have two electric ratios EV1 and EV2. The second jaw clutch 9, located on the solid primary shaft 4, makes it possible to modify the ratio of the combustion engine 3 independently of the electric ratios, in order to establish two combustion ratios Th2 and Th4, independently of the electric ratio. The third jaw clutch 11, located on the transfer shaft 10, makes it possible to establish a third combustion ratio Th3, when it moves to the right in the diagram. It is possible to independently choose, at each instant, the ratio desired on the first electric machine ME 2 and that desired on the combustion engine unit Mth 3 and the second electric machine HSG 5. The combinations of the combustion ratios and of the electric ratios make it possible to produce hybrid ratios, denoted HEVxy, where x is the ratio of the combustion engine, and y is the ratio of the ME.

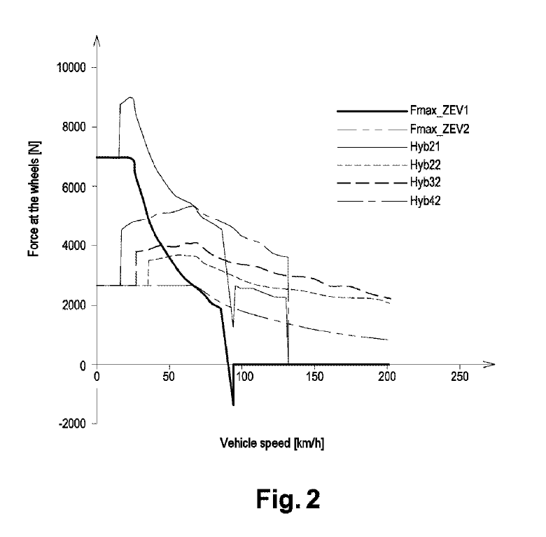

The curves of gear shifts of the transmission are grouped together in FIG. 2. The transmission 1 makes it possible to establish two electric ratios ZE1 and ZE2, and four hybrid ratios Hyb21, Hyb22, Hyb32, Hyb42, as a function of the “combustion ratio” and of the “electric ratio”. The curves plot the maximum efforts achievable (force at the wheels in Newtons) on the electric and hybrid ratios, as a function of the speed.

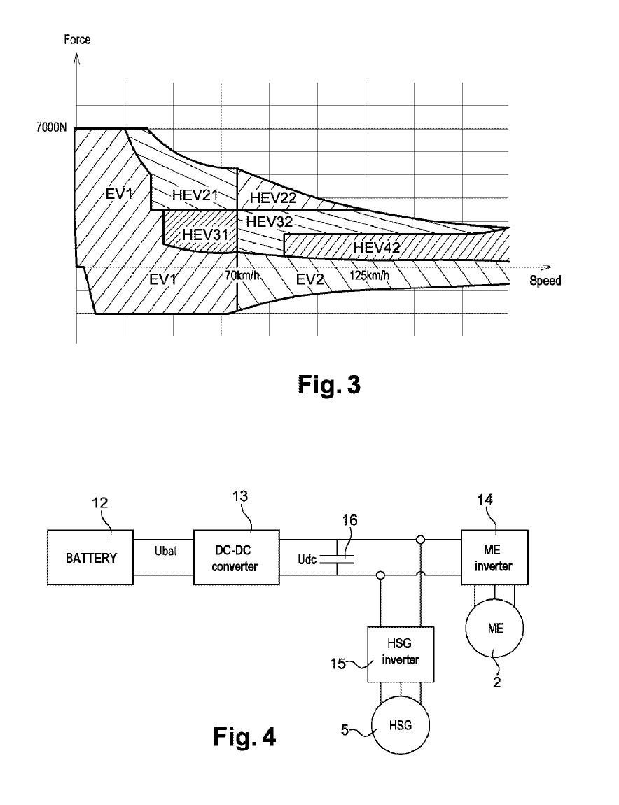

In the intended use, it is possible to agree that the target ratio is always (regardless of the speed of movement) an electric ratio ZEV, once this ratio makes it possible to carry out the torque request of the driver. By default, the engaged ratio becomes the longest hybrid ratio, making it possible to carry out the request. Under these circumstances, the requested ratios can be distributed over a graph, like that of FIG. 3. This figure makes it possible to identify the ratio changes that can occur during conventional driving. It is seen that in full acceleration, there is a transition from HEV22 to HEV32 around 125 km/h. For this shift, the established second combustion ratio must be disconnected from the drive to synchronize the combustion engine with the new ratio thereof. With a battery voltage of 270 V, the first machine ME can provide a power of 35 kW. The second machine HSG can provide a power of 25 kW, while the combustion engine Mth provides 70 kW. The overall power provided by the transmission to the wheel before shifting is then 105 kW. After shifting, the transmission provides substantially the same power (give or take the variation in the power of the combustion engine). However, during shifting, the combustion engine-and-HSG assembly is disconnected from the wheels. Only the ME then supplies power to the wheel, i.e. 35 kW.

The powertrain suffers from a power gap, during this gear shift. At 125 km/h, the power absorbed by the aerodynamics of the vehicle is approximately 25 kW. The power available for acceleration passes in reality from 80 kW to 10 kW during shifting. Such an acceleration drop (of 87%) gives the driver the impression that the vehicle thereof no longer accelerates, despite the torque provided by the main electric machine ME. The feeling thereof is one of a vehicle supplied with a robotized transmission having torque break.

The solution to these problems is via the control of the power available on the electric traction chain of this motive power powertrain, which mainly consists of the combustion engine Mth, of the two electric machines ME and HSG, and of the supply battery for the electric machines, wherein the main machine ME can transmit the torque thereof to the wheels over various transmission ratios, and the secondary electric machine HSG is alternately linked to the input shafts of the combustion engine or of the main electric machine ME.

As indicated above, the intention is to improve the performances of the electric traction chain of such a powertrain, in particular if it is mounted on a non-rechargeable hybrid vehicle. The aim is to have a higher power during prolonged driving under electric traction, and to soften the torque break felt by the driver and the users of the vehicle, during the gear shifts on the combustion traction chain.

The solution to this double problem is highlighted in FIG. 4 that shows the traction battery 12 of the vehicle, which traction battery is linked by a DC-DC converter 13 to the inverters 14, 15, of the two electric machines ME, HSG, which inverters are mounted in parallel on the electric network with an inverter capacitor 16. The proposed control device includes the DC voltage [ML3] converter 13 arranged between the terminals of the battery 12 and those of the electric machines. This converter can impose on them a voltage equal to that of the battery Ubat, or a voltage Udc higher than this. In this device, the supply voltage for the electric machines ME, HSG is preferably regulated by inverters 14, 15, arranged between the converter 13 and the input terminals thereof. It also preferably includes a capacitor 16 between the output terminals of the converter. According to this diagram, the invention provides for adding, between the traction battery and the inverters of the two electric machines, a DC-DC voltage converter, in particular of “step up” type.

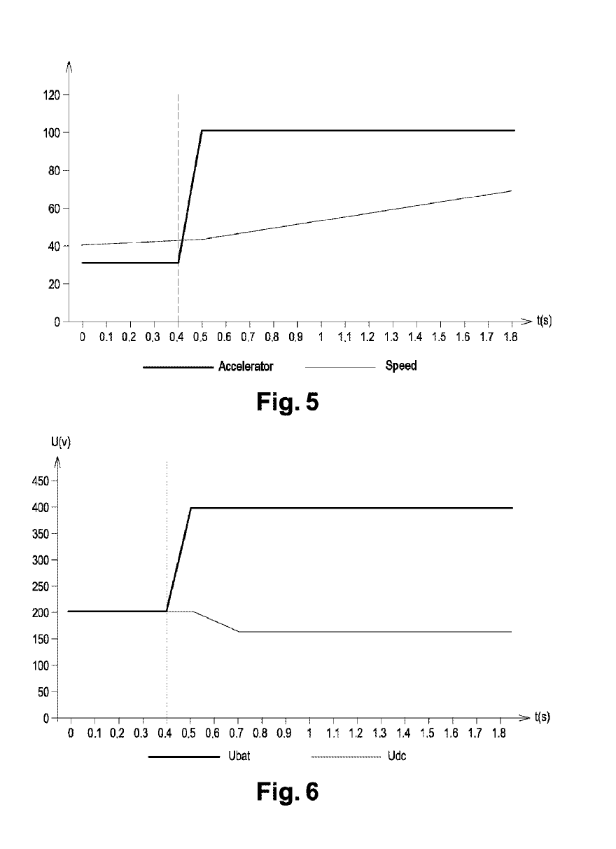

FIGS. 5 to 8 illustrate the way in which the invention solves the power problem during prolonged electric driving in “series hybrid” mode, where the secondary electric machine, driven as a generator by the combustion engine, provides a supplementary electric power to the main electric machine.

When the request of the driver, through the accelerator pedal thereof remains weak, the main electric machine ME can alone provide the traction of the vehicle, by being powered at the voltage of the battery 12. In this situation, the DC-DC converter 13 imposes, on the electric machines, the voltage of the battery Ubat. The secondary machine HSG does not provide power.

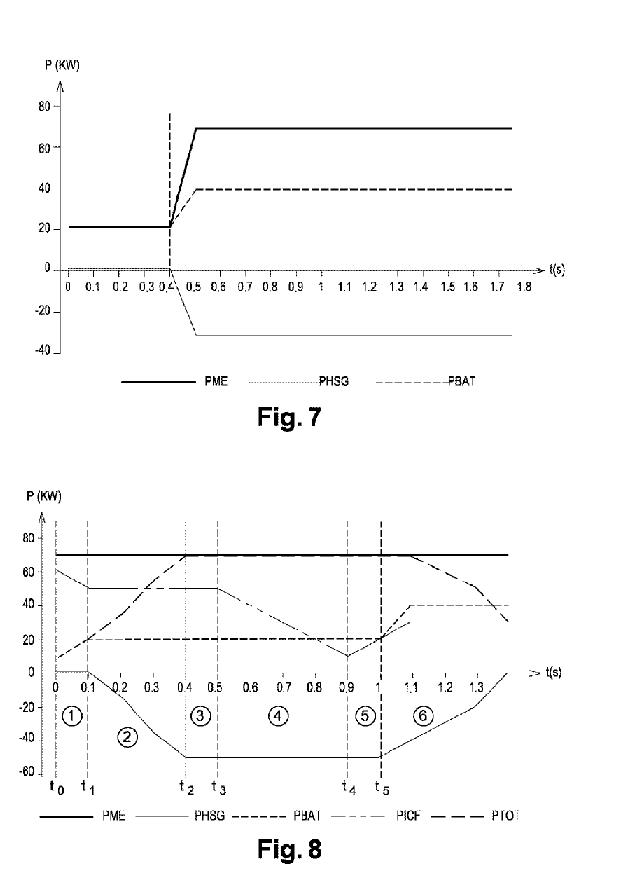

As soon as the driver requests a strong acceleration (cf. FIG. 5), the converter 13 imposes, on the circuit of the electric machines, a voltage Ude higher than the battery voltage Ubat (cf. FIG. 6). The rise in voltage makes it possible to increase the generating power level PHSG of the secondary machine HSG (FIG. 7), as soon as it is driven as a generator by the combustion engine. The main electric machine ME then provides an electric traction power PM equal to the sum of that of the battery PBAT and of the secondary electric machine PHSG.

The DC-DC converter 13 can also impose, on the electric machines, the voltage Udc higher than the battery voltage Ubat, during the combustion ratio changes. FIG. 8 illustrates the distribution of the powers in the vehicle during a HEV22-to-HEV32 ratio shift (cf. FIGS. 2 and 3), wherein the speed of the combustion engine decreases from 4500 rpm to approximately 3000 rpm.

The strategy applied during shifting is broken down into several steps. With reference to the case of shifting from the second to the third combustion ratio (Mth2 to Mth3) illustrated by the figures, these steps are as follows:
Step 1, raising the voltage: as soon as shifting is requested (at to) the converter regulates 10 the voltage to a level of approximately 400 V;
Step 2, transferring torque: before shifting, the power is mainly provided by the combustion engine (PICE); this combustion power level is lowered from t₁ to t₂, to the maximum level that the HSG is capable of absorbing (here 50 KW): starting from t₁, the HSG is gradually driven as a generator until absorbing the power of the combustion engine (from t₂);
Step 3, declutching: at t₂, all of the power provided to the wheel is provided by the electric motor, no torque passes through the jaw clutch, and it is possible to initiate the declutching of the jaw clutch of the ratio Th2;
Step 4, synchronizing the combustion engine speed: at t3, the powertrain is placed in “serial hybrid” mode; by controlling, downward, the power of the combustion engine, the total torque applied to the primary shaft (combustion engine+HSG) becomes negative and the speed falls;
Step 5, clutching: at t₄, the engine speed reaches the value corresponding to the ratio Th3; the clutching of the corresponding jaw clutch is then initiated;
Step 6, restoring torque: at t₅, once the jaw clutch has been connected, an operation similar to step 2 is carried out, by progressively driving the HSG.

In summary, there is:
an increase in the voltage Udc via the converter 13, on the circuit of the electric machines,
a transfer of torque between the combustion engine and the secondary electric machine driven thereby as a generator,
the decoupling of the combustion ratio,
the synchronization of the combustion engine speed with the new ratio to be engaged,
the coupling of the combustion engine to the new ratio thereof,
the restoration of torque on the combustion traction chain by progressively driving the secondary electric machine, and
a decrease in the voltage via the converter on the circuit of the electric machines.

During shifting, the electric power provided by the HSG is transmitted to the main electric machine, which uses it entirely for the traction of the wheels. Without increasing the voltage via the converter, the ME would not have been able to have this energy input, and the acceleration level would have fallen due to the decrease in the combustion power during shifting, before going back up. With the temporary increase in the voltage, the acceleration level remains substantially constant.

The voltage converter can be integrated into the same housing as the ME and HSG inverters, but it can also be integrated into the pack of the traction battery. It is then possible to remove the battery connection relays, since the converter can provide the function of connecting/disconnecting the battery to/from the network. In this configuration, pre-charging the capacitor of the inverters can be carried out by the converter.

In conclusion, the invention results in a transient rise in the voltage of the high-voltage (HV) network during gear shifting. Thanks to the invention, the power provided by the first main electric machine ME, in series hybrid mode, and during the transmission ratio changes of the combustion engine Mth, is increased by operating the second electric machine HSG in regenerative mode. All of the electric power thereof is transmitted to the first main electric machine. It can use it to increase the electric power available for the electric machine in series hybrid mode, or to compensate for the reduction in torque to the wheel, caused by the temporary decoupling of the combustion engine.

1. A method for controlling the power available on the electric traction chain of a powertrain consisting of a combustion engine that can transmit the torque thereof to the wheels over various transmission ratios, of a first electric machine (ME) of a second electric machine (HSG) linked alternately to the input shafts of the combustion engine or of the first electric machine (ME) in the powertrain, and of a supply battery (12) for the electric machines, the supply voltage being established a DC voltage converter (13) arranged between the terminals of the battery and those of the electric machines,
characterized in that
the converter (13) can impose, on the electric machines, a voltage equal to that of the battery (Ubat), or a voltage (Udc) that is greater than this when the driver requests a strong acceleration, and during the combustion ratio changes.

2. The power control method as claimed in claim 1, characterized in that,
when the acceleration request of the driver through the accelerator pedal thereof is weak, the voltage converter (13) imposes the voltage of the battery (Ubat) on the electric machines.

3. The control method as claimed in claim 1, characterized in that
the rise in voltage of the electric machines increases the electric power (PSHG) provided by the secondary electric machine (HSG), when it is driven as a generator by the combustion engine.

4. The power control method as claimed in claim 3, characterized in that
the main electric machine (ME) provides an electric traction power (PM) equal to the sum of that of the battery (PBAT) and of the secondary electric machine (PHSG).

5. The torque control method as claimed in claim 1, characterized in that it includes the following steps:
increase in the voltage (Udc) via the converter (13), on the circuit of the electric machines,
transfer of torque between the combustion engine and the secondary electric machine driven thereby as a generator,
decoupling of the combustion ratio,
synchronization of the combustion engine speed with the new ratio to be engaged,
coupling of the combustion engine to the new ratio thereof,
restoration of torque on the combustion traction chain by progressively driving the secondary electric machine (HSG), and
decrease in the voltage via the converter (13) on the circuit of the electric machines.

6. A device for controlling the power available on the electric traction chain of a powertrain consisting of a combustion engine (3) that can transmit the torque thereof to the wheels over various transmission ratios, of a first electric machine (ME) of a second electric machine (HSG) linked alternately to the input shafts of the combustion engine or of the first electric machine (ME) in the powertrain, and of a supply battery (12) for the electric machines, a DC voltage converter (13) being arranged between the terminals of the battery and those of the electric machines,
characterized in that
the voltage converter can impose, on the electric machines, a voltage equal to that of the battery (Ubat), or a voltage (Udc) that is greater than this when the driver requests a strong acceleration and during the combustion ratio changes.

7. The power control device as claimed in claim 6, characterized in that
the supply voltage for the electric machines (ME, HSG) is regulated by inverters (14, 15), which are arranged between the converter (13) and the input terminals thereof.

8. The power control device as claimed in claim 7, characterized in that it includes a capacitor (16) between the output terminals of the converter (13).
